(19) United States
(12) Patent Application Publication
(10) Pub. No.: US 2024/0014556 A1
(43) Pub. Date: Jan. 11, 2024

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Xiaopu WU, Dongguan (CN)

(21) Appl. No.: 18/471,228

(22) Filed: Sep. 20, 2023

Related U.S. Application Data
(63) Continuation of application No. PCT/CN2022/077301, filed on Feb. 22, 2022.

(30) Foreign Application Priority Data
Mar. 26, 2021 (CN) 202110330835.3

(51) Int. Cl. H01Q 5/10; H01Q 1/48; H01Q 5/328; H01Q 1/24

(52) U.S. Cl. CPC H01Q 5/10; H01Q 1/48; H01Q 5/328; H01Q 1/243

(57) ABSTRACT

An antenna assembly and an electronic device are provided in the disclosure. The antenna assembly includes a radiator, a signal source, and a tuning circuit. The radiator includes a first sub-radiator and a second sub-radiator. The first sub-radiator and the second sub-radiator define a coupling gap therebetween. The first sub-radiator is configured to be coupled to the second sub-radiator through the coupling gap. The first sub-radiator has a first grounding end, a first coupling end, and a feeding point disposed between the first grounding end and the first coupling end. The first grounding end is grounded. The second sub-radiator has a second grounding end, a second coupling end, and a tuning point disposed between the second grounding end and the second coupling end. The first coupling end is spaced apart from the second coupling end by the coupling gap, and the second grounding end is grounded.

### CROSS-REFERENCE TO RELATED APPLICATION(S)

The application is a continuation of International Application No. PCT/CN2022/077301, filed Feb. 22, 2022, which claims priority to Chinese Patent Application No. 202110330835.3, filed Mar. 26, 2021, the entire disclosures of which are incorporated herein by reference.

### TECHNICAL FIELD

The disclosure relates to the field of communications technologies, and in particular, to an antenna assembly and an electronic device.

### BACKGROUND

With the development of communication technologies, electronic devices having communication functions are becoming more and more popular, and imposing higher requirements on Internet speed. Therefore, how to widen an antenna bandwidth of the electronic device becomes a technical problem to be solved.

### SUMMARY

In a first aspect, an antenna assembly is provided in implementations of the disclosure. The antenna assembly includes a radiator, a signal source, and a tuning circuit. The radiator includes a first sub-radiator and a second sub-radiator. The first sub-radiator and the second sub-radiator define a coupling gap therebetween, and the first sub-radiator is configured to be coupled to the second sub-radiator through the coupling gap. The first sub-radiator has a first grounding end, a first coupling end, and a feeding point disposed between the first grounding end and the first coupling end. The first grounding end is grounded. The second sub-radiator has a second grounding end, a second coupling end, and a tuning point disposed between the second grounding end and the second coupling end. The first coupling end is spaced apart from the second coupling end by the coupling gap, and the second grounding end is grounded. The signal source is electrically coupled to the feeding point. One end of the tuning circuit is electrically connected to the tuning point, the other end of the tuning circuit is grounded, and the tuning circuit is configured to tune the second sub-radiator to enable the second sub-radiator to be able to support at least two resonant modes.

In a second aspect, an electronic device is provided in the implementations of the disclosure. The electronic device includes a housing and the antenna assembly provided in the first aspect. The radiator is disposed in the housing. Alternatively, the radiator is disposed on the housing. Alternatively, the radiator is integrated into the housing, and the tuning circuit and the signal source are disposed in the housing.

### BRIEF DESCRIPTION OF THE DRAWINGS

To describe technical solutions in implementations of the disclosure more clearly, the following briefly introduces the accompanying drawings required for describing the implementations. Apparently, the accompanying drawings in the following description only illustrate some implementations of the disclosure. Those of ordinary skill in the art may also obtain other drawings based on these accompanying drawings without creative efforts.

FIG. 1 is a schematic structural view of an electronic device provided in implementations of the disclosure.

FIG. 2 is a schematic exploded structural view of the electronic device in FIG. 1.

FIG. 3 is a schematic structural diagram of an antenna assembly provided in implementations of the disclosure.

FIG. 4 illustrates a graph of S-parameters of the antenna assembly in FIG. 3.

FIG. 5 is a graph of system efficiency of the antenna assembly in FIG. 3.

FIG. 6 is a diagram illustrating a current density distribution corresponding to a first resonant mode in FIG. 4.

FIG. 7 is a diagram illustrating a current density distribution corresponding to a second resonant mode in FIG. 4.

FIG. 8 is a diagram illustrating a current density distribution corresponding to a third resonant mode in FIG. 4.

FIG. 9 is a diagram illustrating a current density distribution corresponding to a fourth resonant mode in FIG. 4.

FIG. 10 is a schematic structural diagram of a tuning circuit provided in an implementation of the disclosure.

FIG. 11 is a schematic structural diagram of a tuning circuit provided in an implementation of the disclosure.

FIG. 12 is a schematic structural diagram of a tuning circuit provided in an implementation of the disclosure.

FIG. 13 is a schematic structural diagram of a tuning circuit provided in an implementation of the disclosure.

FIG. 14 is a schematic structural diagram of a tuning circuit provided in an implementation of the disclosure.

FIG. 15 is a schematic structural diagram of a matching circuit of the antenna assembly in FIG. 3.

FIG. 16a is a first schematic structural diagram of the antenna assembly in FIG. 3 that is provided with an adjustable element.

FIG. 16b is a second schematic structural diagram of the antenna assembly in FIG. 3 that is provided with an adjustable element.

FIG. 17a is a third schematic structural diagram of the antenna assembly in FIG. 3 that is provided with an adjustable element.

FIG. 17b is a fourth schematic structural diagram of the antenna assembly of FIG. 3 provided with an adjustable element.

FIG. 18 is a fifth schematic structural diagram of the antenna assembly of FIG. 3 provided with an adjustable element.

FIG. 19 illustrates graphs of S-parameters of the antenna assembly in FIG. 3 provided with an adjustable element.

FIG. 20 is a first schematic structural diagram illustrating that the antenna assembly in FIG. 3 is disposed in a frame.

FIG. 21 is a second schematic structural diagram illustrating that the antenna assembly in FIG. 3 is disposed in a frame.

FIG. 22 is a schematic structural diagram illustrating that a radiator of the antenna assembly in FIG. 3 is integrated into a frame.

FIG. 23 is a schematic structural diagram illustrating that a radiator of the antenna assembly in FIG. 3 is disposed in a frame.

### DETAILED DESCRIPTION

Technical solutions in implementations of the disclosure will be described clearly and completely hereinafter with reference to the accompanying drawings in the implementations of the disclosure. Apparently, the described implementations are merely some of rather than all of the implementations of the disclosure. The term “implementation” or “example” referred to in various points in the specification does not necessarily all refer to the same implementation, nor does it refer to an independent or alternative implementation that is mutually exclusive with other implementations. It is expressly and implicitly understood by those skilled in the art that the implementations referred to herein can be combined with other implementations.

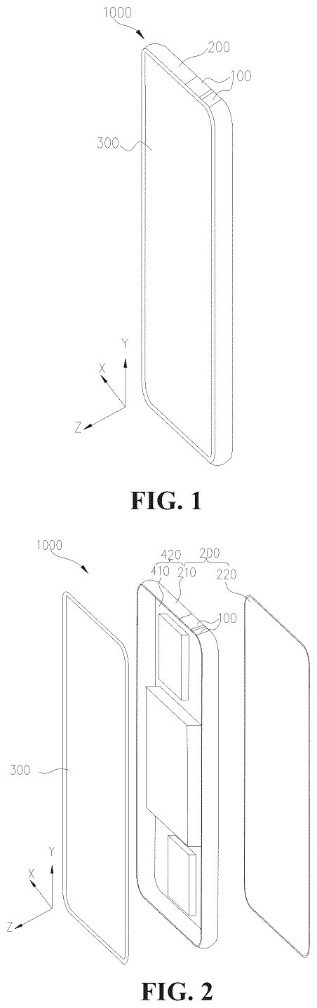

Referring to FIG. 1, FIG. 1 is a schematic structural view of an electronic device provided in implementations of the disclosure. The electronic device 1000 includes an antenna assembly 100. The antenna assembly 100 is configured to transmit/receive (transmit and/or receive) an electromagnetic wave signal to implement a communication function of the electronic device 1000. A position of the antenna assembly 100 in the electronic device 1000 is not specifically limited in the disclosure. The electronic device 1000 further includes a display screen 300 and a housing 200 that cover each other. The antenna assembly 100 may be disposed inside the housing 200 of the electronic device 1000, or partially integrated with the housing 200, or partially disposed outside the housing 200. The antenna assembly 100 may also be disposed on a retractable assembly of the electronic device 1000, in other words, at least part of the antenna assembly 100 may also extend out of the electronic device 1000 along with the retractable assembly of the electronic device 1000, and retract into the electronic device 1000 along with the retractable assembly. Alternatively, a length of the entire antenna assembly 100 may increase as the retractable assembly of the electronic device 1000 extends.

The electronic device 1000 includes, but is not limited to, a device that can transmit/receive an electromagnetic wave signal, such as a telephone, a television, a tablet computer, a mobile phone, a camera, a personal computer, a notebook computer, an on-board equipment, an earphone, a watch, a wearable device, a base station, a vehicle-borne radar, and a customer premise equipment (CPE). In the disclosure, the electronic device 1000 is exemplified as a mobile phone, and other devices can refer to the detailed illustration in the disclosure. The antenna assembly 100 and the electronic device 1000 are provided in the disclosure with a widened antenna bandwidth.

For ease of illustration, with reference to a view angle of the electronic device 1000 in FIG. 1, a width direction of the electronic device 1000 is defined as an X-axis direction, a length direction of the electronic device 1000 is defined as a Y-axis direction, and a thickness direction of the electronic device 1000 is defined as a Z-axis direction. The X-axis direction, Y-axis direction, and Z-axis direction are mutually perpendicular. A direction indicated by an arrow is a forward direction.

Referring to FIG. 2, the housing 200 includes a frame 210 and a rear cover 220. A middle plate 410 is formed in the frame 210 through injection molding. The middle plate 410 defines multiple mounting grooves for mounting various electronic components. The middle plate 410 and the frame 210 cooperatively form a middle frame 420 of the electronic device 1000. The display screen 300 and the rear cover 220 both cover the middle frame 420 to define accommodating spaces on two sides of the middle frame 420. The electronic device 1000 further includes components that can implement basic functions of a mobile phone, such as a battery, a camera, a microphone, a receiver, a speaker, a face recognition module, and a fingerprint recognition module, which are received in the accommodating spaces and will not be repeatedly described in the implementations.

The antenna assembly 100 provided in the disclosure will be specifically described below with reference to the accompanying drawings. The antenna assembly 100 provided in the disclosure includes, but is not limited to, the following implementations.

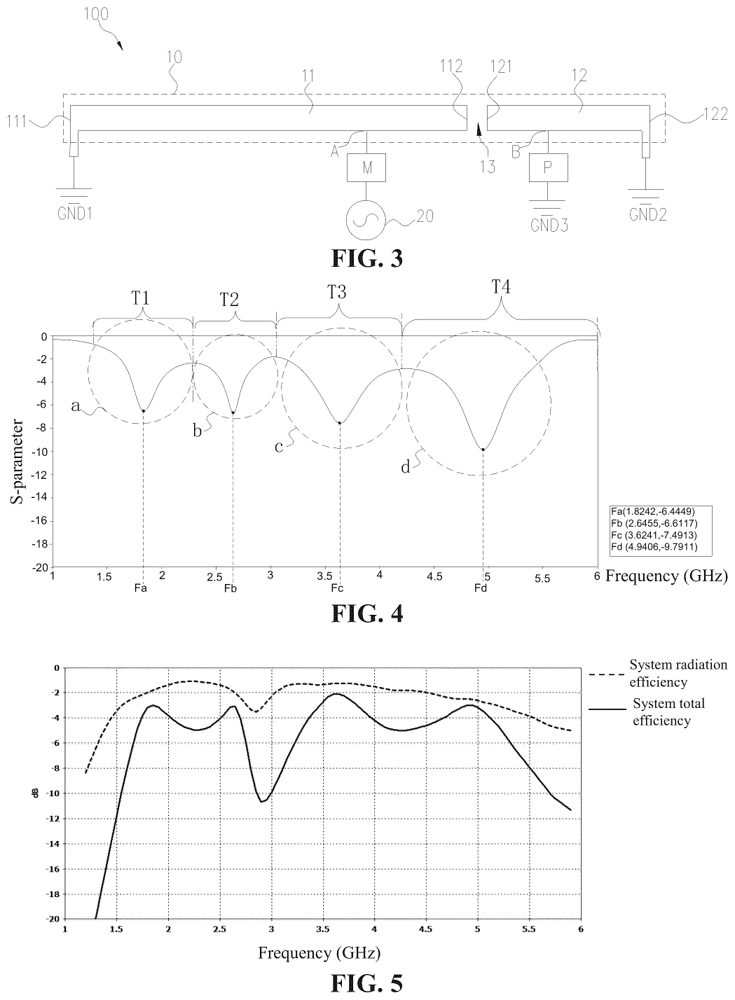

Referring to FIG. 3, the antenna assembly 100 includes at least a radiator 10, a matching circuit M, and a signal source 20.

Referring to FIG. 3, the radiator 10 includes a first sub-radiator 11 and a second sub-radiator 12. The first sub-radiator 11 and the second sub-radiator 12 define a coupling gap 13 therebetween. The first sub-radiator 11 is configured to be coupled to the second sub-radiator 12 through the coupling gap 13. In the implementations, an example that both the first sub-radiator 11 and the second sub-radiator 12 are in a linear strip shape is taken for illustration. In other implementations, both the first sub-radiator 11 and the second sub-radiator 12 may also be in a bent strip shape or other shapes.

Referring to FIG. 3, the first sub-radiator 11 includes a first grounding end 111, a first coupling end 112, and a feeding point A disposed between the first grounding end 111 and the first coupling end 112. The first grounding end 111 is electrically connected to a ground GND1.

In the implementations, the first grounding end 111 and the first coupling end 112 are two opposite ends of the first sub-radiator 11 that is in a linear strip shape. In other implementations, the first sub-radiator 11 is in a bent shape, and the first grounding end 111 and the first coupling end 112 may not be opposite to each other in a linear direction, but the first grounding end 111 and the first coupling end 112 are two tail ends of the first sub-radiator 11. The first sub-radiator 11 further has the feeding point A disposed between the first grounding end 111 and the first coupling end 112. A specific position of the feeding point A at the first sub-radiator 11 is not limited in the disclosure.

Referring to FIG. 3, the second sub-radiator 12 includes a second coupling end 121, a second grounding end 122, and a tuning point B disposed between the second grounding end 122 and the second coupling end 121. The second grounding end 122 is electrically connected to a ground GND2. In the implementations, the second coupling end 121 and the second grounding end 122 are two opposite ends of the second sub-radiator 12 that is in a linear strip shape. The first sub-radiator 11 and the second sub-radiator 12 may be arranged along a straight line or along a substantially straight line (i.e., with relatively small tolerances in design). In other implementations, the first sub-radiator 11 and the second sub-radiator 12 may also be arranged in a staggered manner in an extending direction to provide a clearance space for other components, among other possibilities.

Referring to FIG. 3, the first coupling end 112 and the second coupling end 121 define a coupling gap 13 therebetween. The first coupling end 112 faces the second coupling end 121, and the first coupling end 112 is spaced apart from the second coupling end 121 by the coupling gap 13. The coupling gap 13 is a gap between the first coupling end 112 of the first sub-radiator 11 and the second coupling end 121 of the second sub-radiator 12. For example, the width of the coupling gap 13 may be, but is not limited to, 0.5 mm to 2 mm. The first sub-radiator 11 is configured to be in capacitive coupling with the second sub-radiator 12 through the coupling gap 13. In one example, the first sub-radiator 11 and the second sub-radiator 12 may be regarded as two parts of the radiator 10 separated by the coupling gap 13.

The first sub-radiator 11 is configured to be in capacitive coupling with the second sub-radiator 12 through the coupling gap 13. Here, “capacitive coupling” means that an electric field may generate between the first sub-radiator 11 and the second sub-radiator 12, a signal of the first sub-radiator 11 can be transmitted to the second sub-radiator 12 through the electric field, and a signal of the second sub-radiator 12 can be transmitted to the first sub-radiator 11 through the electric field, so that an electrical signal can be conducted between the first sub-radiator 11 and the second sub-radiator 12 that is not in contact with or is not in direct connection with the first sub-radiator 11. In the implementations, the first sub-radiator 11 can generate an electric field under excitation of the signal source 20, and energy of the electric field can be transferred to the second sub-radiator 12 through the coupling gap 13 to enable the second sub-radiator 12 to generate an excitation current. In other words, the second sub-radiator 12 may also be referred to as a parasitic radiator of the first sub-radiator 11.

In the disclosure, the first sub-radiator 11 and the second sub-radiator 12 are not limited in shape and configuration. The first sub-radiator 11 and the second sub-radiator 12 can be, but are not limited to, strip-shaped, sheet-shaped, rod-shaped, coatings, films, and the like. In a case where the first sub-radiator 11 and the second sub-radiator 12 are in a strip shape, a trajectory along which the first sub-radiator 11 extends and a trajectory along which the second sub-radiator 12 extends are not limited herein, and thus the first sub-radiator 11 and the second sub-radiator 12 may both extend along a trajectory such as a straight line, a curve, or a polyline. The radiator 10, along the trajectory, may be in a linear shape with a uniform width, and may also be in a strip shape with varying widths, including a strip shape that gradually changes in width, a strip shape with a widened region, and the like.

The radiator 10 of the antenna assembly 100 can be electrically grounded through implementations including, but not limited to the following. Alternatively, the antenna assembly 100 has a reference ground. In other words, each of the ground GND1, the ground GND2, and the ground GND3 is part of the reference ground of the antenna assembly 100. The reference ground includes, but is not limited to, a metal plate, a metal layer formed inside a flexible printed circuit board, or the like. The first grounding end 111 of the first sub-radiator 11 and the second grounding end 122 of the second sub-radiator 12 are electrically connected to the reference ground through a conductive member such as a grounding resilient piece, solder, and conductive adhesive. In a case where the antenna assembly 100 is disposed in the electronic device 1000, the reference ground of the antenna assembly 100 can be electrically connected to a reference ground of the electronic device 1000.

Optionally, the antenna assembly 100 does not have a reference ground, and the radiator 10 of the antenna assembly 100 is electrically connected to a reference ground of the electronic device 1000 or a reference ground of an electronic component in the electronic device 1000 through a direct electrical connection or through an intermediate conductive connecting member. In the disclosure, an example that the antenna assembly 100 is disposed at the electronic device 1000 is taken for illustration, a metal alloy in the middle plate 410 and the display screen 300 of the electronic device 1000 is taken as the reference ground. The first grounding end 111 and the second grounding end 122 of the antenna assembly 100 are electrically connected to the reference ground of the electronic device 1000 through a conductive member such as a grounding resilient piece, solder, or conductive adhesive. In other words, each of the ground GND1, the ground GND2, and the ground GND3 is part of the reference ground of the electronic device 1000.

Referring to FIG. 3, optionally, one end of the matching circuit Mis electrically connected to the feeding point A, and the signal source 20 is electrically connected to the other end of the matching circuit M. The signal source 20 may be a radio frequency transceiving chip configured to transmit/receive a radio frequency signal or a feeder electrically connected to a radio frequency transceiving chip that is configured to transmit/receive a radio frequency signal. The matching circuit M includes, but is not limited to, a branch formed by a capacitor, an inductor, a resistor, or the like, multiple selection branches formed by a switch, a capacitor, an inductor, a resistor, or the like, or an adjustable element such as a variable capacitor.

In the disclosure, since a branch of the first sub-radiator 11 is electrically connected to the signal source 20, the first sub-radiator 11 can transmit/receive electromagnetic wave signals under excitation of the signal source 20. Although a branch of the second sub-radiator 12 is not electrically connected to the signal source 20, the second sub-radiator 12 can be coupled to the first sub-radiator 11, so that an excitation current at the first sub-radiator 11 can enable the second sub-radiator 12 to generate an excitation current through the coupling gap. In other words, the second sub-radiator 12 can be indirectly excited by the signal source 20, and the second sub-radiator 12 may also be referred to as a parasitic radiator of the first sub-radiator 11.

Further, the antenna assembly 100 also includes a tuning circuit P. One end of the tuning circuit P is electrically connected to the tuning point B, and the other end of the tuning circuit P is grounded. The tuning circuit P is configured to tune the second sub-radiator 12 to enable the second sub-radiator 12 to be able to support at least two resonant modes. It is noted that, the second sub-radiator 12 is able to support a particular resonant mode, which indicates that during operation of the antenna assembly 100 in the particular resonant mode, the second sub-radiator 12 serves as the dominant radiator, and the first sub-radiator 11 also participates in the transmission of a resonant current, thereby forming a current loop.

The resonant mode indicates that the radiator 10 has high electromagnetic wave transmission/reception efficiency at and around a resonant frequency. Corresponding to FIG. 4, each concave curve segment corresponds to a resonant mode. It can be understood that each resonant mode has a resonant frequency (that is, a frequency at the lowest point of each concave curve segment). Each resonant mode covers a band which includes a resonant frequency. For example, a resonant frequency of a particular resonant mode is 2.5 GHz, and a band covered by the particular resonant mode is 1.7 GHz-2.7 GHz. The foregoing data is merely exemplary and should not be construed as limitations on the resonant modes described in the disclosure.

In conventional technology, within some of practical application bands (for example, a practical application bands range from 1450 MHz to 6000 MHz, and some of the practical application bands ranges from 1450 MHz to 2700 MHz), antennas can only support a single resonant mode. However, a single resonant mode is often insufficient to cover a relatively wide bandwidth (for example, a bandwidth of B3+N1, B3+N41, or B3+B1+B7) and is insufficient to support multiple practical application bands (which may include B1, B3, B7, B39, B41, N1, N3, N7, N39, and N41). Consequently, antennas in conventional technology fail to support, within the frequency range of 1450 MHz-2700 MHz, combinations such as B3+N1 or B3+N41 that can achieve dual connection between the 4G radio access network and the 5G-NR (EN-DC), or combinations such as B3+B1+B7 that can achieve carrier aggregation (CA). It is noted that the above bands are merely exemplary and should not be construed as limitations on bands that can be covered in the disclosure. Here, a frequency range of B3 is 1710 MHz-1785 MHz and 1805 MHz-1880 MHz, a frequency range of each of B1 and N1 is 1920 MHz-1980 MHz and 2110 MHz-2170 MHz, a frequency range of B7 is 2550 MHz-2570 MHz and 2620 MHz-2690 MHz, and a frequency range of N41 is 2496 MHz-2690 MHz.

In the implementations of the disclosure, the tuning circuit P is electrically connected to the second sub-radiator 12, and the tuning circuit P is configured to enable the second sub-radiator 12 to support at least two different current distributions under excitation of the first sub-radiator 11. The at least two current distributions enable the second sub-radiator 12 to support at least two resonant modes. The at least two resonant modes may cover wider bandwidth or more bands to increase the bandwidth of the antenna assembly 100, thereby improving a throughput of signal transmission/reception, and improving a data transmission rate of the antenna assembly 100. A resonant frequency of at least one resonant mode of the second sub-radiator 12 can be adjusted to be within some of the practical application bands (for example, ranging from 1450 MHz to 2700 MHz). For example, each of a resonant frequency of the at least one resonant mode of the second sub-radiator 12 and a resonant frequency of one resonant mode of the first sub-radiator 11 can be adjusted to be within some of the practical application bands, thus in some of the practical application bands, at least two resonant modes can be supported to achieve a coverage of a wider bandwidth. In addition, a wide bandwidth (for example, a bandwidth covering B3+N1, B3+N41 or B3+B1+B7) can be covered, and multiple practical application bands (including B1, B3, B7, B39, B41, N1, N3, N7, N39, and N41) can be supported. A resonant frequency of each of at least two resonant modes of the second sub-radiator 12 may also be adjusted to be in some of the practical application bands, thus in some of the practical application bands, at least two resonant modes can be supported to achieve coverage of a wider bandwidth. Resonant modes in the practical application bands can be provided by the first sub-radiator 11, or by the second sub-radiator 12, or by both the first sub-radiator 11 and the second sub-radiator 12, which is not limited herein. 1450 MHz-2700 MHz is only an illustrative range of the above-mentioned some of the practical application bands, and in other implementations, a range of some of the practical application bands may also be 1700 MHz-2700 MHz, 2500 MHz-3600 MHz, or the like.

It is noted that, a resonant frequency of a resonant mode is correlated with a physical length of a radiator. In other words, a physical length of a radiator corresponds to a resonant frequency of the resonant mode. After a physical length of a radiator is determined, a resonant frequency of a resonant mode corresponding to the radiator is determined, and the radiator is configured to support the resonant mode corresponding to the physical length of the radiator. In this way, a bandwidth of a band covered by the radiator is relatively small. For example, after a physical length of the radiator 10 of the antenna is determined, a resonant frequency of the radiator 10 is determined. If no improvement is carried out to the second sub-radiator 12, the second sub-radiator 12 cannot support a relatively large number of resonant modes, and therefore cannot support a relatively wide bandwidth or a relatively large number of bands.

In the antenna assembly 100 and the electronic device 1000 provided in the disclosure, the antenna assembly 100 includes the radiator 10, the signal source 20, and the tuning circuit P. The radiator 10 includes the first sub-radiator 11 and the second sub-radiator 12. The first sub-radiator 11 and the second sub-radiator 12 define the coupling gap 13 therebetween. The first sub-radiator 11 is configured to be coupled to the second sub-radiator 12 through the coupling gap 13. The first sub-radiator 11 has the first grounding end 111, the first coupling end 112, and the feeding point A disposed between the first grounding end 111 and the first coupling end 112. The first grounding end 111 is grounded. The second sub-radiator 12 has the second grounding end 122, the second coupling end 121, and the tuning point B disposed between the second grounding end 122 and the second coupling end 121. The first coupling end 112 is spaced apart from the second coupling end by the coupling gap 13, and the second grounding end is grounded. The signal source 20 is electrically connected to the feeding point A. One end of the tuning circuit P is electrically connected to the tuning point B, and the other end of the tuning circuit P is grounded. The tuning circuit P is configured to tune current distribution at the second sub-radiator 12 to enable the second sub-radiator 12 to be able to support at least two resonant modes, so that the antenna assembly 100 can support a relatively wide bandwidth or cover more bands, thereby improving the throughput and the data transmission rate of the antenna assembly 100 that is applied to the electronic device 1000, improving the communication quality of the electronic device 1000. In addition, when the antenna assembly 100 can support a relatively wide bandwidth, no adjustable element is needed to switch between various bands, thereby eliminating the need for an adjustable element, saving costs, and simplifying a structure of the antenna assembly 100.

The tuning circuit P provided in the disclosure enables the second sub-radiator 12 to be able to support at least two resonant modes. In the implementations, an example that the tuning circuit P enables the second sub-radiator 12 to be able to support two resonant modes is taken for illustration. For implementations in which the second sub-radiator 12 is configured to support three or more resonant modes, reference may be made to the following implementations, and details are not repeatedly described herein.

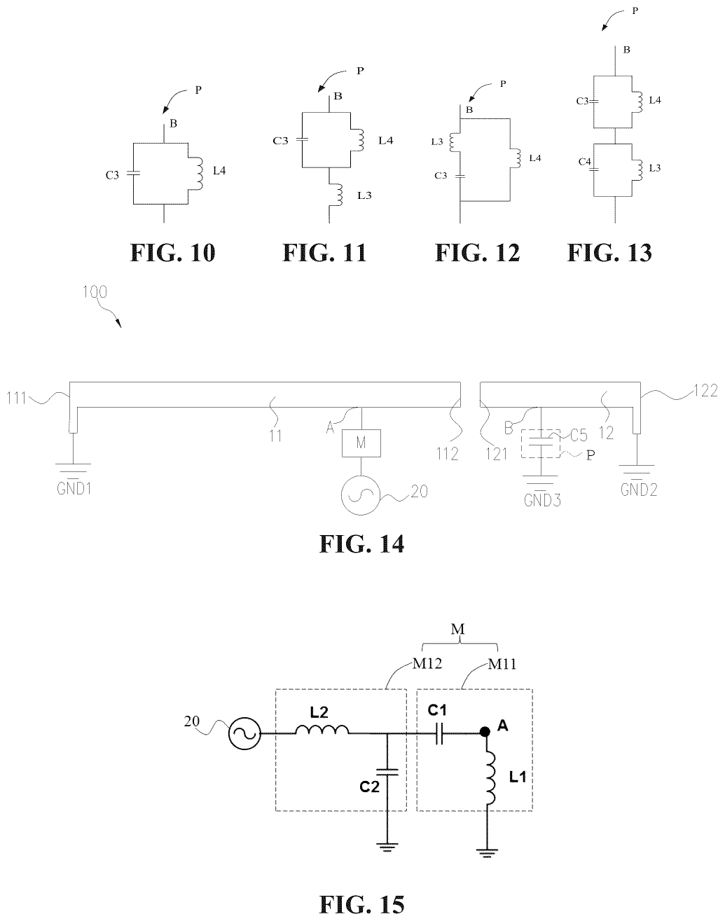

Optionally, the tuning circuit P has different band-pass or band-stop characteristics at different frequencies. For example, the tuning circuit P has a band-stop characteristic in a first preset band (i.e., around 2653 MHz), and has a band-pass characteristic in a second preset band (i.e., around 4594 MHz). In this way, the tuning circuit P can control a resonant current corresponding to the first preset band to be grounded through the second grounding end 122, and control a resonant current corresponding to the second preset band to be grounded through the tuning circuit P. In this way, the tuning circuit P is configured to enable resonant currents corresponding to different bands to have different current paths, and accordingly, the different current paths enable the second sub-radiator 12 to support different resonant modes, and thus the second sub-radiator 12 can support two resonant modes. In a case where three or more resonant modes need to be supported, the second sub-radiator 12 can be design to increase or adjust the number of internal components of the tuning circuit P, so that the tuning circuit P has band-pass characteristics at different bands and band-stop characteristics at different bands. The specific structure of the tuning circuit P is not limited in the disclosure, as long as the tuning circuit P can achieve the foregoing functions. Detailed illustration will be given below with reference to FIGS. 10 to 13.

Optionally, the tuning circuit P includes a tuning capacitor. The above-mentioned two resonant modes can also be achieved by adjusting a length of the second sub-radiator 12 to adjust frequencies of resonant modes. Moreover, the tuning circuit P is a tuning capacitor, and the second sub-radiator 12 is grounded through the tuning capacitor. Optionally, the tuning capacitor is a small capacitor. Since a frequency of the first preset band is different from a frequency of the second preset band, the tuning capacitor with a small capacitance has different capacitive reactances for different bands. For example, the tuning capacitor of a small capacitance has better band-pass characteristic for a relatively high frequency, and has particular band-stop characteristic for a relatively low frequency. When the first preset band is a relatively low frequency and the second preset band is a relatively high frequency, the tuning capacitor can also perform path allocation for the resonant current corresponding to the first preset band and the resonant current corresponding to the second preset band, thereby supporting two resonant modes. Detailed illustration will be given below with reference to FIG. 14.

Optionally, when a component, which is electrically connected to the second sub-radiator 12, of the tuning circuit P is a small capacitor, the small capacitor may serve as a tuning capacitor, so that path allocation for the resonant current corresponding to the first preset band and the resonant current corresponding to the second preset band can be achieved, thereby supporting two resonant modes.

It is noted that, the first preset band and the second preset band are not specifically limited herein. Optionally, one or both of the first preset band and the second preset band are set within some of the practical application bands.

The following provides illustrative examples of resonant modes supported by the first sub-radiator 11 and the second sub-radiator 12 of the antenna assembly 100 in FIG. 3.

Optionally, the first sub-radiator 11 is configured to support at least one resonant mode under excitation of the signal source 20. The number of resonant modes supported by the first sub-radiator 11 is not limited in the disclosure.

Referring to FIG. 4, an example that each of the first sub-radiator 11 and the second sub-radiator 12 is configured to support two resonant modes is taken for illustration. It is noted that, the first sub-radiator 11 is configured to support a particular resonant mode, which indicates that during operation of the antenna assembly 100 in the particular resonant mode, the first sub-radiator 11 serves as the dominant radiator, and the second sub-radiator 12 also participates in the transmission of a resonant current. The second sub-radiator 12 is configured to support a particular resonant mode, which indicates that during operation of the antenna assembly 100 in the particular resonant mode, the second sub-radiator 12 serves as the dominant radiator, and the first sub-radiator 11 also participates in the transmission of a resonant current.

Resonant modes supported by the radiator 10 include a first resonant mode a, a second resonant mode b, a third resonant mode c, and a fourth resonant mode d. A resonant frequency corresponding to the first resonant mode a is a first resonant frequency Fa, a resonant frequency corresponding to the second resonant mode b is a second resonant frequency Fb, a resonant frequency corresponding to the third resonant mode c is a third resonant frequency Fc, and a resonant frequency corresponding to the fourth resonant mode d is a fourth resonant frequency Fd. The first resonant mode a covers a first band T1, the second resonant mode b covers a second band T2, the third resonant mode c covers a third band T3, and the fourth resonant mode d covers a fourth band T4.

Alternatively, the first sub-radiator 11 is configured to support two resonant modes among the first resonant mode a, the second resonant mode b, the third resonant mode c, and the fourth resonant mode d, and the second sub-radiator 12 is configured to support the other two resonant modes among the first resonant mode a, the second resonant mode b, the third resonant mode c, and the fourth resonant mode d. Due to different resonant frequencies correspond to different lengths of radiators, when multiple resonant modes with significant frequency differences are supported, there be significant differences in the lengths of the corresponding radiators. In the implementations, a reasonable distribution of supported resonant modes is applied to the first sub-radiator 11 and the second sub-radiator 12, that is, each sub-radiator is configured to two resonant modes, thereby ensuring a reduction in the overall size of the radiator 10 of the antenna assembly 100 while supporting a relatively large number of resonant modes. In other words, the radiator 10 with a relatively small size is utilized to support a relatively large number of resonant modes as much as possible.

The number of resonant modes supported by the first sub-radiator 11 and the number of resonant modes supported by the second sub-radiator 12 are not limited in the disclosure. In other implementations, the first sub-radiator 11 is configured to support one resonant mode, and the second sub-radiator 12 is configured to support three resonant modes. Alternatively, the first sub-radiator 11 is configured to support three resonant modes, and the second sub-radiator 12 is configured to support two resonant modes. Alternatively, the first sub-radiator 11 is configured to support three resonant modes, and the second sub-radiator 12 is configured to support three resonant modes. Other examples will not be enumerated one by one herein.

Optionally, referring to FIG. 4, the resonant modes supported by the first sub-radiator 11 include the first resonant mode a and the fourth resonant mode d. The resonant modes supported by the second sub-radiator 12 include the second resonant mode b and the third resonant mode c. In the implementations, the resonant frequency of the first resonant mode a, the resonant frequency of the second resonant mode b, the resonant frequency of the third resonant mode c, and the resonant frequency of the fourth resonant mode d sequentially increase. For example, the resonant frequency of the first resonant mode a is 1.8242 GHz, the resonant frequency of the second resonant mode b is 2.6455 GHz, the resonant frequency of the third resonant mode c is 3.6241 GHz, and the resonant frequency of the fourth resonant mode d is 4.9406 GHz. The above data are merely exemplary and should not be construed as limitations on the resonant frequency of the first resonant mode a, the resonant frequency of the second resonant mode b, the resonant frequency of the third resonant mode c, and the resonant frequency of the fourth resonant mode d.

In other implementations, the resonant frequency of the second resonant mode b, the resonant frequency of the first resonant mode a, the resonant frequency of the third resonant mode c, and the resonant frequency of the fourth resonant mode d sequentially increase. In other implementations, the resonant frequency of the second resonant mode b, the resonant frequency of the first resonant mode a, the resonant frequency of the fourth resonant mode d, and the resonant frequency of the third resonant mode c sequentially increase. For example, the resonant frequency of the second resonant mode b is 1.8242 GHz, the resonant frequency of the first resonant mode a is 2.6455 GHz, the resonant frequency of the fourth resonant mode d is 3.6241 GHz, and the resonant frequency of the third resonant mode c is 4.9406 GHz. In other implementations, the resonant frequency of the first resonant mode a, the resonant frequency of the fourth resonant mode d, the resonant frequency of the second resonant mode b, and the resonant frequency of the third resonant mode c sequentially increase. In other implementations, the resonant frequency of the second resonant mode b, the resonant frequency of the third resonant mode c, the resonant frequency of the first resonant mode a, and the resonant frequency of the fourth resonant mode d sequentially increase. Other examples will not be enumerated one by one herein.

Optionally, the first resonant mode a is the ¼ wavelength mode and the fourth resonant mode d is the ¾ wavelength mode, and in both the first resonant mode a and the fourth resonant mode d, a resonant current flows through the same section of the radiator 10. The ¼ wavelength mode is a fundamental mode of an antenna, and in the ¼ wavelength mode, the antenna has high conversion efficiency of transmission/reception. The ¾ wavelength mode is a third-order mode of an antenna.

By setting a physical length of the first sub-radiator 11, a structure of the matching circuit, and a position of the feeding point A, the first sub-radiator 11 can support the first resonant mode a and the fourth resonant mode d, thus the first sub-radiator 11 can be effectively utilized to support multiple resonant modes, thereby widening the bandwidth of the antenna assembly 100 or increasing the number of bands covered by the antenna assembly 100, and reducing the overall size of the antenna assembly 100.

The second resonant mode b and the third resonant mode c are adjacent resonant modes. The tuning circuit P is designed and adjusted to enable the second sub-radiator 12 to support two resonant modes, thereby increasing the number of resonant modes supported by the second sub-radiator 12 without changing the length of the second sub-radiator 12. The second resonant mode b and the third resonant mode c are both ¼ wavelength modes and supported by different parts of the second sub-radiator 12. In other words, conversion efficiencies of transmission/reception in bands corresponding to the second resonant mode b and the third resonant mode c are both high.

By the above designations, the first sub-radiator 11 is configured to support the first resonant mode a and the fourth resonant mode d that are spaced apart from the first resonant mode a, and the second sub-radiator 12 is configured to support the second resonant mode b and the third resonant mode c that is adjacent to and continuous with the second resonant mode b, and the second resonant mode b and the third resonant mode c are designed to be between the first resonant mode a and the fourth resonant mode d. This allocation of resonant modes enables the radiator 10 with a shorter length to support more resonant modes, thereby facilitating the miniaturization of the antenna module 100.

Bandwidths of bands corresponding to the first resonant mode a, the second resonant mode b, the resonant mode c, and the fourth resonant mode d, respectively, are not specifically limited herein.

Alternatively, referring to FIG. 4, each of the first resonant mode a and the second resonant mode b covers a middle-high band (MHB). Each of the third resonant mode c and the fourth resonant mode d covers an ultra-high band (UHB). The MHB ranges from 1 GHz to 3 GHz, and the UHB ranges from 3 GHz from 6 GHz. In other words, the antenna assembly 100 can support not only the MHB, but also the UHB, i.e., achieve a wide bandwidth coverage of the MHB and the UHB.

In other implementations, the first resonant mode a may cover a low band (LB), the second resonant mode b may cover the MHB, the third resonant mode c may cover the MHB, and the fourth resonant mode d may cover the UHB. In other implementations, the first resonant mode a may cover the LB, the second resonant mode b may cover the LB, the third resonant mode c may cover the MHB, and the fourth resonant mode d may cover the UHB, and so on, which are not enumerated one by one herein.

The disclosure does not specifically limit whether bands respectively supported by the first resonant mode a, the second resonant mode b, the resonant mode c, and the fourth resonant mode d are continuous. Specifically, a band(s) supported by the first resonant mode a (i.e., the first band T1), a band(s) supported by the second resonant mode b (i.e., the second band T2), a band(s) supported by the third resonant mode c (i.e., the third band T3), and a band(s) supported by the fourth resonant mode d (i.e., the fourth band T4) may be continuous or discontinuous. In a case where the above four bands are continuous, it indicates that at least two adjacent bands among the four bands at least partially overlap with each other (including overlapping at one frequency point). In a case where the above four bands are discontinuous, it indicates that any two adjacent bands among the four bands do not overlap with each other. With the above design, a structure of the antenna assembly 100 is relatively simple, the number of resonant modes supported by the antenna assembly 100 is increased, and the number of bands covered by the antenna assembly 100 is increased. Specifically, in a case where the bands covered by the antenna assembly 100 are continuous, adjacent continuous bands can be combined to form a band with a relatively wide bandwidth, so that the antenna assembly 100 can achieve a relatively wide bandwidth coverage. Even if the bands covered by the antenna assembly 100 are discontinuous, as the number of bands covered by the antenna assembly 100 increases, the antenna assembly 100 can support more bands of suppliers.

Optionally, the band(s) supported by the first resonant mode a (i.e., the first band T1), the band(s) supported by the second resonant mode b (i.e., the second band T2), the band(s) supported by the third resonant mode c (i.e., the third band T3), and the band(s) supported by the fourth resonant mode d (i.e., the fourth band T4) are combined to form a relatively wide band.

For example, the first band T1 is 1.45 GHz-2.25 GHz, the second band T2 is 2.25 GHz-3 GHz, the third band T3 is 3 GHz-4.2 GHz, and the fourth band T4 is 4.2 GHz-6 GHz. A target application band formed by the combination of the first band T1, the second band T2, the third band T3, and the fourth band T4 is 1.45 GHz-6 GHz, so that the antenna assembly 100 can cover any one or combination of B3, B39, B1, B7, B41, N3, N39, N1, N7, N41, N77, N78, N79, and other bands within a frequency range of 1.45 GHz-6 GHz. It can be seen from FIG. 4 that, the resonant mode a and the resonant mode b are within the frequency range of 1450 MHz-2700 MHz, thus a wide-band antenna may be achieved. An impedance of the matching circuit M may affect a resonant frequency of the resonant mode a and a resonant frequency of the resonant mode b, thus the resonant frequencies of the resonant modes a and b can be shifted, within a particular range, towards a high frequency or a low frequency by changing an impedance matching value of the matching circuit M, so that the antenna assembly 100 can cover at least some of bands such as B32 and N75 (for example, cover a band around 1500 MHz). Here, a frequency range of each of B3 and N3 is 1710 MHz-1785 MHz and 1805 MHz-1880 MHz, a frequency range of each of B39 and N39 is 1880 MHz-1920 MHz, a frequency range of each of B1 and N1 is 1920 MHz-1980 MHz and 2110 MHz-2170 MHz, a frequency range of each of B7 and N7 is 2550 MHz-2570 MHz and 2620 MHz-2690 MHz, a frequency range of each of B41 and N41 is 2496 MHz-2690 MHz, a frequency range of N77 is 3300 MHz-4200 MHz, a frequency range of N78 is 3400 MHz-3600 MHz, a frequency range of N79 is 4800 MHz-5000 MHz.

It is noted that, the first band T1 is 1.45 GHz-2.25 GHz, the second band T2 is 2.25 GHz-3 GHz, the third band T3 is 3 GHz-4.2 GHz, the fourth band T4 is 4.2 GHz-6 GHz, and the target application band is 1.45 GHz-6 GHz, which are merely exemplary and should not be construed as limitations on the disclosure. A band covered by resonant modes supported by the antenna assembly 100 in the disclosure may be, but is not limited to, less than 1 GHz, 1 GHz-6 GHz, greater than 6 GHz, and so on.

The disclosure does not specifically limit a signal type of a band(s) covered by each of the first resonant mode a, the second resonant mode b, the third resonant mode c, and the fourth resonant mode d.

Optionally, each of the first resonant mode a, the second resonant mode b, the third resonant mode c, and the fourth resonant mode d covers at least one of 4^{th} generation (4G) long term evolution (LTE) band or 5^{th} generation (5G) New Radio (NR) band. When each of the first resonant mode a, the second resonant mode b, the third resonant mode c, and the fourth resonant mode d covers the 4G LTE band or the 5G NR band, a combination of a band covered by the first resonant mode a, a band covered by the second resonant mode b, a band covered by the third resonant mode c, and a band covered by the fourth resonant mode d forms a target application band, where the target application band covers 1.45 GHz-6 GHz.

Optionally, the target application band can support any one or both of the 4G LTE band and the 5G NR band. In other words, the antenna assembly 100, within the target application band of 1.45 GHz-6 GHz, can support the 4G LTE band or the 5G NR band. The antenna assembly 100, within the target application band of 1.45 GHz-6 GHz, can also support a combination of some frequency ranges within the 4G LTE band and some frequency ranges within the 5G NR band, thereby achieving the dual connection between the 5G NR and the 4G LTE.

Optionally, a transmission/reception band of the antenna assembly 100 provided in the implementation is formed by aggregating multiple carriers (carriers are radio waves of a specific frequency), thereby achieving carrier aggregation (CA), increasing a transmission bandwidth, improving a throughput, and improving a signal transmission rate. For example, the first band T1 is 1.45 GHz-2.25 GHz, the second band T2 is 2.25 GHz-3 GHz, the third band T3 is 3 GHz-4.2 GHz, and the fourth band T4 is 4.2 GHz-6 GHz. The target application band formed by aggregating the first band T1, the second band T2, the third band T3, and the fourth band T4 covers 1.45 GHz-6 GHz. For the 4G LTE band, bands supported by the antenna assembly 100 include, but are not limited to, at least one of B1, B2, B3, B4, B7, B32, B38, B39, B40, B41, B48, and B66. For the 5G NR band, and the bands supported by the antenna assembly 100 include, but are not limited to, at least one of N1, N2, N3, N4, N7, N32, N38, N39, N40, N41, N48, and N66. The antenna assembly 100 provided in the disclosure can cover any combination of the NR5G band and the 4G LTE band. The antenna assembly 100 may support only 4G LTE signals. Alternatively, the antenna assembly 100 may support only 5G NR signals. Alternatively, the antenna assembly 100 may support both 4G LTE signals and 5G NR signals, thereby achieving the dual connection between the 4G radio access network and the 5G-NR (EN-DC).

The above-mentioned bands may be the MHB that may be adopted by multiple operators. The antenna assembly 100 provided in the disclosure may support any one or combination of the above-mentioned bands to enable the antenna assembly 100 provided in the disclosure to support different models of the electronic device 1000 corresponding to multiple different operators, thus there is no need to use different antenna structures for different operators, thereby further improving the application range and compatibility of the antenna assembly 100.

Referring to FIG. 5, FIG. 5 illustrates efficiencies of the antenna assembly 100 provided in the disclosure in a full-screen environment. In FIG. 5, a dotted line represents a radiation efficiency curve of the antenna assembly 100, and a solid line represents a matched total efficiency curve of the antenna assembly 100. In the disclosure, the metal alloy in the middle frame 420 and the display screen 300 is taken as the reference ground GND, and a distance between the radiator 10 of the antenna assembly 100 and the reference ground GND is less than or equal to 0.5 mm. In other words, the antenna assembly 100 has a clearance area of 0.5 mm, which satisfies environmental requirements of the electronic device 1000 such as a current mobile phone. It can be seen from FIG. 5 that the antenna assembly 100 has a high efficiency bandwidth even in an extremely small clearance area (in a full-screen mobile phone environment). It can be seen from the above that the antenna assembly 100 provided in the disclosure still has high radiation efficiency in an extremely small clearance area. Thus, when applied to the electronic device 1000 with a relatively small clearance area, the antenna assembly 100 allows the electronic device 1000 to have smaller overall size than other antennas that require a relatively large clearance area to achieve high efficiency.

In the above implementations, a structure of the antenna assembly 100, the first resonant mode a, the second resonant mode b, the third resonant mode c, and the fourth resonant mode d are illustrated to exemplify achievement of a wider bandwidth coverage and support of more bands. The first resonant mode a, the second resonant mode b, the third resonant mode c, and the fourth resonant mode d are exemplified hereinafter with reference to the resonant current.

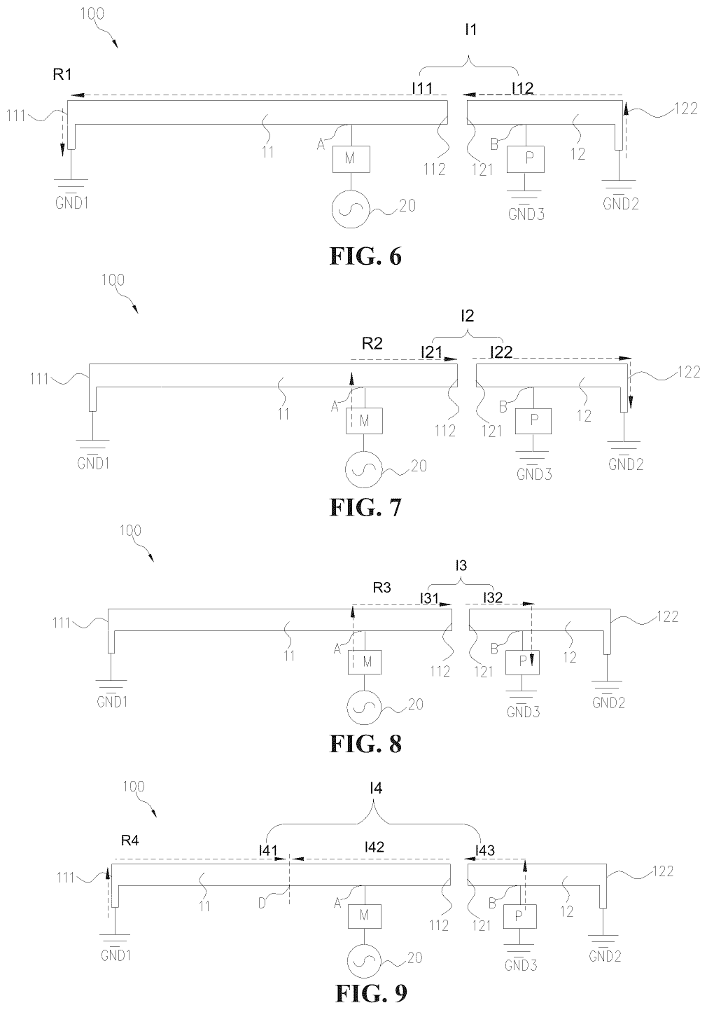

Referring to FIGS. 6 to 9, the radiator 10 has at least four current density distributions under excitation of the signal source 20, which include a first current density distribution R1, a second current density distribution R2, a third current density distribution R3, and a fourth current density distribution R4.

Referring to FIG. 6, a current density distribution corresponding to the first resonant mode a includes, but is not limited to, the first current density distribution R1 in which a first resonant current I1 is distributed between the first grounding end 111 and the second grounding end 122. The first resonant current I1 may flow from the first grounding end 111 to the first coupling end 112, and flow from the second coupling end 121 to the second grounding end 122. Alternatively, the first resonant current I1 may flow from the second grounding end 122 to the second coupling end 121, and flow from the first coupling end 112 to the first grounding end 111.

Specifically, the first resonant current I1 includes a first resonant sub-current I11 and a second resonant sub-current I12. The first sub-radiator 11 is configured to generate the first resonant sub-current I11 under excitation of the signal source 20, and the first resonant sub-current I11 is configured to excite the second sub-radiator 12 through the coupling gap 13 to generate the second resonant sub-current I12, where a flow direction of the first resonant sub-current I11 is the same as a flow direction of the second resonant sub-current I12.

Part of the first sub-radiator 11 between the first grounding end 111 and the first coupling end 112 is configured to support the first resonant mode a under excitation of the first resonant current I1. Alternatively, the first resonant mode a is the ¼ wavelength mode, in other words, a physical length of the part of the first sub-radiator 11 between the first grounding end 111 and the first coupling end 112 is about ¼ of a wavelength corresponding to the resonant frequency of the first resonant mode a, so that the part of the first sub-radiator 11 between the first grounding end 111 and the first coupling end 112 can support the ¼ wavelength resonant mode under excitation of the first resonant current I1, thereby achieving high transmission/reception efficiency at and around the resonant frequency of the first resonant mode a.

Referring to FIG. 7, a current density distribution corresponding to the second resonant mode b includes, but is not limited to, the second current density distribution R2 in which a second resonant current I2 corresponding to the second resonant mode b is distributed between the feeding point A and the second grounding end 122. The second resonant current I2 may, but is not limited to, flow from the feeding point A to the first coupling end 112, and flow from the second coupling end 121 to the second grounding end 122. Alternatively, the second resonant current I2 may flow from the second grounding end 122 to the second coupling end 121, and flow from the first coupling end 112 to the feeding point A.

Specifically, the second resonant current I2 includes a third resonant sub-current I21 and a fourth resonant sub-current I22. The first sub-radiator 11 is configured to generate the third resonant sub-current I21 under excitation of the signal source 20, and the third resonant sub-current I21 is configured to excite the second sub-radiator 12 to generate the fourth resonant sub-current I22 through the coupling gap 13, where a flow direction of the third resonant sub-current I21 is the same as a flow direction of the fourth resonant sub-current I22.

Part of the second sub-radiator 12 between the second grounding end 122 and the second coupling end 121 is configured to support the second resonant mode b under excitation of the second resonant current I2. Optionally, the second resonant mode b is the ¼ wavelength mode, in other words, a physical length of the part of the second sub-radiator 12 between the second grounding end 122 and the second coupling end 121 is about ¼ of a wavelength corresponding to the resonant frequency of the second resonant mode b, so that the part of the second sub-radiator 12 between the second grounding end 122 and the second coupling end 121 can support the ¼ wavelength resonant mode under excitation of the second resonant current I2, thereby achieving high transmission/reception efficiency at and around the resonant frequency of the second resonant mode b.

Referring to FIG. 8, a current density distribution corresponding to the third resonant mode c includes, but is not limited to, a third current density distribution R3 in which a third resonant current corresponding to the third resonant mode c is distributed between the feeding point A and the tuning point B. The third resonant current I3 may, but is not limited to, flow from the feeding point A to the first coupling end 112, and flow from the second coupling end 121 to the tuning point B. Alternatively, the third resonant current I3 may flow from the tuning point B to the second coupling end 121, and flow from the first coupling end 112 to the feeding point A.

Specifically, the third resonant current I3 includes a fifth resonant sub-current I31 and a sixth resonant sub-current I32. The first sub-radiator 11 is configured to generate the fifth resonant sub-current I31 under excitation of the signal source 20, and the fifth resonant sub-current I31 is configured to excite the second sub-radiator 12 to generate the sixth resonant sub-current I32 through the coupling gap 13, where a flow direction of the fifth resonant sub-current I31 is the same as a flow direction of the sixth resonant sub-current I32.

Part of the second sub-radiator 12 between the tuning point B and the second coupling end 121 is configured to support the third resonant mode c under excitation of the third resonant current 3.

Referring to FIG. 9, a current density distribution corresponding to the fourth resonant mode d includes, but is not limited to, a fourth current density distribution R4 in which a fourth resonant current I4 corresponding to the fourth resonant mode d is distributed between the first grounding end 111 and the tuning point B. The part of the first sub-radiator 11 between the first grounding end 111 and the first coupling end 112 is configured to support the fourth resonant mode d under excitation of the fourth resonant current I4.

Specifically, the fourth resonant current I4 includes a seventh resonant sub-current I41, an eighth resonant sub-current I42, and a ninth resonant current I43. A current flow direction of the seventh resonant sub-current I41 is opposite to a current flow direction of the eighth resonant sub-current I42. The current flow direction of the eighth resonant sub-current I42 is the same as a current flow direction of the ninth resonant current I43.

The first sub-radiator 11 is configured to generate a seventh resonant sub-current I41 and an eighth resonant sub-current I42 under excitation of the signal source 20, where the seventh resonant sub-current I41 flows from the first grounding end 111 to a current reverse point D, and the eighth resonant sub-current I42 flows from the first coupling end 112 to the current reverse point D. Optionally, the current reverse point D is positioned between the feeding point A and the first grounding end 111. The first sub-radiator 11 is further configured to excite, through the coupling gap 13, the part of the second sub-radiator 12 between the tuning point B and the second coupling end 121 to generate the ninth resonant current I43, where the ninth resonant current I43 flows to the second coupling end 121 through the tuning circuit P and the tuning point B.

It is noted that, the foregoing current density distributions are main current density distributions, and should not be construed as limitations on all currents.

In the implementations, the tuning circuit P is configured to control, in the first resonant mode a and the second resonant mode b, a resonant current to be grounded through the second grounding end 122, and to control, in the third resonant mode c and the fourth resonant mode d, a resonant current to be grounded through the tuning circuit P. The control principle is based on a fact that the tuning circuit P has different band-pass/band-stop characteristics for different bands. Specifically, the tuning circuit P has at least two resonant frequencies f1 and f2. For a frequency lower than the first resonant frequency f1, the tuning circuit P is inductive. The tuning circuit P presents a band-stop characteristic for the first resonant frequency f1. For a frequency between the first resonant frequency f1 and the second resonant frequency f2, the tuning circuit P is capacitive. The tuning circuit P presents a band-pass characteristic for the second resonant frequency f2. For a frequency higher than the second resonant frequency f2, the tuning circuit P is inductive.

Assuming that the first resonant frequency f1 of the tuning circuit P is adjusted to be greater than both the resonant frequency of the first resonant mode a and the resonant frequency of the second resonant mode b, at this point, the tuning circuit P presents a substantial “open-circuit” characteristic for both a resonant current corresponding to the first resonant mode a and a resonant current corresponding to the second resonant mode b. Consequently, the resonant current corresponding to the first resonant mode a and the resonant current corresponding to the second resonant mode b are mainly grounded through the second grounding end 122. In other words, the tuning circuit P is inductive at both a resonant point of the first resonant mode a and a resonant point of the second resonant mode b. As such, the first current density distribution R1 and the second current density distribution R2 are formed.

Assuming that the first resonant frequency f1 of the tuning circuit P is adjusted to be less than both the resonant frequency of the third resonant mode c and the resonant frequency of the fourth resonant mode d, and the second resonant frequency f2 of the tuning circuit P is adjusted to be greater than the resonant frequency of the third resonant mode c and less than the resonant frequency of the fourth resonant mode d, the resonant frequency of the fourth resonant mode d is adjusted to be close to the second resonant frequency f2, and at this point, the tuning circuit P has a small inductor grounded near the resonant frequency of the fourth resonant mode d. In this case, the tuning circuit P is substantially “on” for a resonant current corresponding to the third resonant mode c and a resonant current corresponding to the fourth resonant mode d, and thus, the resonant current corresponding to the third resonant mode c and the resonant current corresponding to the fourth resonant mode d are mainly grounded through the tuning circuit P. In other words, the tuning circuit P is capacitive at a resonant point of the third resonant mode c, and the tuning circuit P is inductive and grounded through a small inductor at a resonant point of the fourth resonant mode d. As such, the third current density distribution R3 and the fourth current density distribution R4 are formed.

The disclosure does not specifically limit a structure of the tuning circuit P, as long as the tuning circuit P can achieve the above-mentioned two resonant frequencies and be inductive and capacitive at the above-mentioned two resonant frequencies. respectively. Several possible implementations of the tuning circuit P are illustrated in the following with reference to the accompanying drawings. The tuning circuit P provided in the disclosure includes, but is not limited to, the following implementations.

Referring to FIG. 10, FIG. 10 is a schematic diagram of the tuning circuit P provided in a first implementation of the disclosure. The tuning circuit P includes a first capacitor unit C3 and a first inductor unit L4, where one end of the first capacitor unit C3 and one end of the first inductor unit L4 are both electrically connected to the tuning point B, and the other end of the first capacitor unit C3 and the other end of the first inductor unit L4 are both electrically connected to the ground GND3. The first capacitor unit C3 may adjust a band-pass band of the tuning circuit P, and the first capacitor unit C3 and the first inductor unit L4 that are connected in parallel may adjust a band-stop band of the tuning circuit P. The first resonant frequency f1 and the second resonant frequency f2 of the tuning circuit P can be adjusted by adjusting a capacitance of the first capacitor unit C3 and an inductance of the first inductor unit L4, so that the first resonant frequency f1 can be adjusted to be greater than both the resonant frequency of the first resonant mode a and the resonant frequency of the second resonant mode b and less than both the resonant frequency of the third resonant mode c and the resonant frequency of the fourth resonant mode d, and the second resonant frequency f2 can be adjusted to be greater than both the resonant frequency of the third resonant mode c and the resonant frequency of the fourth resonant mode d, thereby achieving the current density distribution corresponding to the first resonant mode a, the current density distribution corresponding to the second resonant mode b, the current density distribution corresponding to the third resonant mode c, and the current density distribution corresponding to the fourth resonant mode d, and supporting the first resonant mode a, the second resonant mode b, the third resonant mode c, and the fourth resonant mode d.

Referring to FIG. 11, FIG. 11 is a schematic diagram of the tuning circuit P provided in a second implementation of the disclosure. On the basis of the tuning circuit P in FIG. 10, the tuning circuit P in FIG. 11 further includes a second inductor unit L3. One end of the second inductor unit L3 is electrically connected to a node where the other end of the first capacitor unit C3 is connected to the other end of the first inductor unit L4. The other end of the second inductor unit L3 is connected to the ground GND3. The first resonant frequency f1 and the second resonant frequency f2 of the tuning circuit P can be adjusted by adjusting the capacitance of the first capacitor unit C3, an inductance of the first inductor unit L4, and an inductance of the second inductor unit L3, so that the first resonant frequency f1 can be adjusted to be greater than both the resonant frequency of the first resonant mode a and the resonant frequency of the second resonant mode b and less than both the resonant frequency of the third resonant mode c and the resonant frequency of the fourth resonant mode d, and the second resonant frequency f2 can be adjusted to be greater than both the resonant frequency of the third resonant mode c and the resonant frequency of the fourth resonant mode d, thereby achieving the current density distribution corresponding to the first resonant mode a, the current density distribution corresponding to the second resonant mode b, the current density distribution corresponding to the third resonant mode c, and the current density distribution corresponding to the fourth resonant mode d, and supporting the first resonant mode a, the second resonant mode b, the third resonant mode c, and the fourth resonant mode d.

Referring to FIG. 12, FIG. 12 is a schematic diagram of the tuning circuit P provided in a third implementation of the disclosure. On the basis of the tuning circuit P in FIG. 10, the tuning circuit P in FIG. 12 further includes a second inductor unit L3. One end of the second inductor unit L3 is electrically connected to the tuning point B, and the other end of the second inductor unit L3 is electrically connected to one end of the first capacitor unit C3. That is, the second inductor unit L3 is in series connection with the first capacitor unit C3. The first capacitor unit C3 and the second inductor unit L3 are configured to adjust a band-pass band. The first capacitor unit C3, the first inductor unit L4, and the second inductor unit L3 are configured to adjust a band-stop band. The first resonant frequency f1 and the second resonant frequency f2 of the tuning circuit P can be adjusted by adjusting the capacitance of the first capacitor unit C3, the inductance of the first inductor unit L4, and the inductance of the second inductor unit L3, so that the first resonant frequency f1 can be adjusted to be greater than both the resonant frequency of the first resonant mode a and the resonant frequency of the second resonant mode b and less than both the resonant frequency of the third resonant mode c and the resonant frequency of the fourth resonant mode d, and the second resonant frequency f2 can be adjusted to be greater than both the resonant frequency of the third resonant mode c and the resonant frequency of the fourth resonant mode d, thereby achieving the current density distribution corresponding to the first resonant mode a, the current density distribution corresponding to the second resonant mode b, the current density distribution corresponding to the third resonant mode c, and the current density distribution corresponding to the fourth resonant mode d, and supporting the first resonant mode a, the second resonant mode b, the third resonant mode c, and the fourth resonant mode d.

The first capacitor unit C3, the first inductor unit L4, and the second inductor unit L3 form a frequency selection filter circuit, and have different impedance characteristics for different bands, so that the tuning point B has different boundary conditions in different bands, thereby enabling more modes to be excited.

For example, the first capacitor unit C3 has a capacitance of 0.8 pF, the first inductor unit L4 has an inductance of 3 nH, and the second inductor unit L3 has an inductance of 1.5 nH, so that the tuning circuit P presents a band-stop characteristic around 2653 MHz and a band-pass characteristic around 4594 MHz. Optionally, the first resonant frequency f1 is 2653 MHz, and the second resonant frequency f2 is 4594 MHz, so that both a current at the tuning point B in the first resonant mode a and a current at the tuning point B in the second resonant mode b can be grounded through the second grounding end 122, and both a current at the tuning point B in the third resonant mode c and a current at the tuning point B in the fourth resonant mode d can be grounded through the tuning circuit P.

Referring to FIG. 13, FIG. 13 is a schematic diagram of the tuning circuit P provided in a fourth implementation of the disclosure. On the basis of the tuning circuit P in FIG. 12, the tuning circuit P in FIG. 12 further includes a second capacitor unit C4. One end of the second capacitor unit C4 is electrically connected to one end of the second inductor unit L3, and the other end of the second capacitor unit C4 is electrically connected to the other end of the second inductor unit L3. The first resonant frequency f1 and the second resonant frequency f2 of the tuning circuit P can be adjusted by adjusting the capacitance of the first capacitor unit C3, the inductance of the first inductor unit L4, the inductance of the second inductor unit L3, and a capacitance of the second capacitor unit C4, so that the first resonant frequency f1 can be adjusted to be greater than both the resonant frequency of the first resonant mode a and the resonant frequency of the second resonant mode b and less than both the resonant frequency of the third resonant mode c and the resonant frequency of the fourth resonant mode d, and the second resonant frequency f2 can be adjusted to be greater than both the resonant frequency of the third resonant mode c and the resonant frequency of the fourth resonant mode d, thereby achieving the current density distribution corresponding to the first resonant mode a, the current density distribution corresponding to the second resonant mode b, the current density distribution corresponding to the third resonant mode c, and the current density distribution corresponding to the fourth resonant mode d, and supporting the first resonant mode a, the second resonant mode b, the third resonant mode c, and the fourth resonant mode d.

For example, the first resonant mode a supports bands such as B1, B39, and B3, the second resonant mode b supports bands such as B7 and B41, the third resonant mode c supports bands such as N77 and N78, and the fourth resonant mode d supports bands such as N79. The tuning circuit P may have a large capacitor grounded for the N78 band, and have a small inductor grounded for the N79 band.

It is noted that the tuning circuits P provided in the foregoing implementations may be combined with each other to form another tuning circuit.

Alternatively, referring to FIG. 14, the tuning circuit P includes a tuning capacitor C5. One end of the tuning capacitor C5 is electrically connected to the tuning point B, and the other end of the tuning capacitor C5 is grounded. In a case where the tuning circuit P is electrically connected to the tuning point B, a resonant frequency offset in the first resonant mode a and a resonant frequency offset the second resonant mode b can be adjusted by adjusting (e. g., reducing) the length of the second sub-radiator 12.

The structure of the matching circuit Mis illustrated below with reference to the accompanying drawings.

Referring to FIG. 15, the matching circuit M includes a first matching unit M11 and a second matching unit M12. Each of the first matching unit M11 and the second matching unit M12 includes a capacitor and an inductor. One end of the first matching unit M11 is electrically connected to the feeding point A, another end of the first matching unit M11 is electrically connected to one end of the second matching unit M12, and yet another end of the first matching unit M11 is electrically connected to the ground. Another end of the second matching unit M12 is electrically connected to the signal source 20, and still another end of the second matching unit M12 is electrically connected to the ground. The first matching unit M11 is configured to tune the first resonant mode a, and the second matching unit M12 is configured to tune the third resonant mode c. Alternatively, the first matching unit M11 is configured to tune the third resonant mode c, and the second matching unit M12 is configured to tune the first resonant mode a. The first matching unit M11 and the second matching unit M12 are configured to cooperatively tune the second resonant mode b and the fourth resonant mode d.

Alternatively, referring to FIG. 15, the first matching unit M11 includes a first capacitor C1 and a first inductor L1. One end of the first capacitor C1 is electrically connected to the feeding point A. The other end of the first capacitor C1 is electrically connected to the one end of the second matching unit M12, and one end of the first inductor L1 is electrically connected to the feeding point A. The other end of the first inductor L1 is electrically grounded. Alternatively or additionally, the second matching unit M12 includes a second capacitor C2 and a second inductor L2. One end of the second capacitor C2 is electrically connected to the another end of the first matching unit M11, and the other end of the second capacitor C2 is electrically grounded. One end of the second inductor L2 is electrically connected to the another end of the first matching unit M11, and the other end of the second inductor L2 is electrically connected to the signal source 20.

By designing the matching circuit M, an impedance matching value in a transmission path of a radio frequency signal output by the signal source 20 can be adjusted, so that the signal transmission/reception efficiency of the antenna assembly 100 can be improved, and the resonant frequency of the first resonant mode a, the resonant frequency of the second resonant mode b, the resonant frequency of the third resonant mode c, and the resonant frequency of the first resonant mode d can also be tuned, thereby realizing a wide-frequency coverage within the practical application bands.

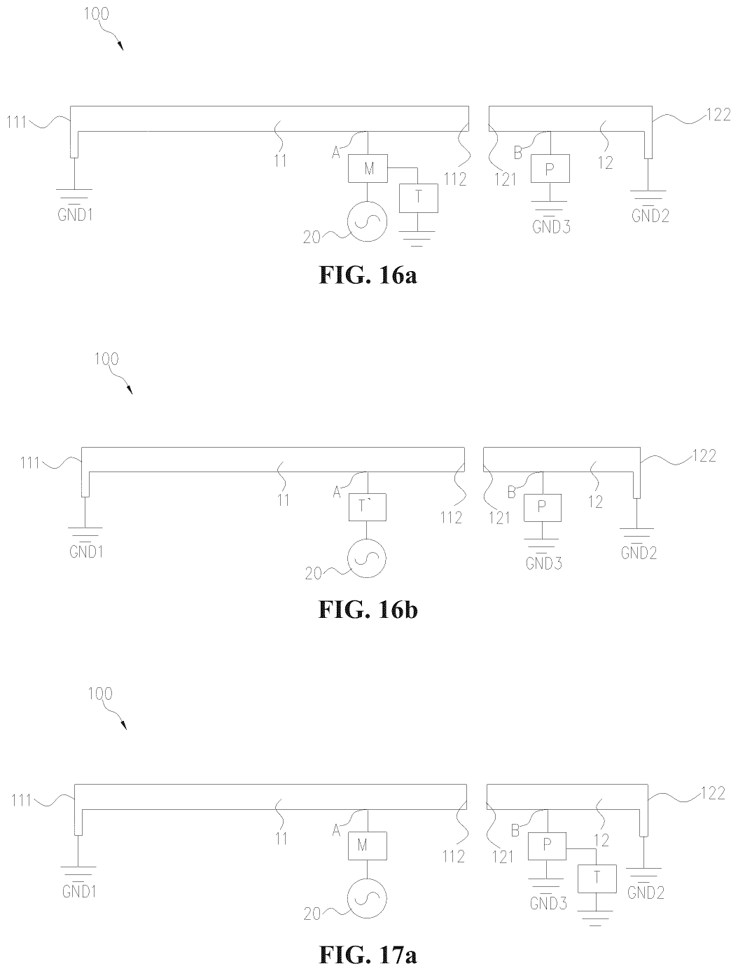

Referring to FIG. 16a, the antenna assembly 100 includes at least one adjustable element T.

Optionally, referring to FIG. 16a, one end of the adjustable element Tis electrically connected to the matching circuit M and the other end of the adjustable element Tis grounded, so that the first resonant mode a, the second resonant mode b, the third resonant mode c, and the fourth resonant mode d can be tuned, thereby adjusting the resonant frequency of the first resonant mode a and the resonant frequency of the second resonant mode b.

In other implementations, referring to FIG. 16b, the adjustable element Tis integrated into the matching circuit M to form a circuit T to tune the first resonant mode a and the fourth resonant mode d, thereby adjusting the resonant frequency of the first resonant mode a and the resonant frequency of the second resonant mode b. It can be understood that, integration of the adjustable element T into the matching circuit M means that the adjustable element T may be used as part of the matching circuit M. For example, the circuit T in FIG. 16b is a circuit formed by integrating the adjustable element Tinto the matching circuit M.

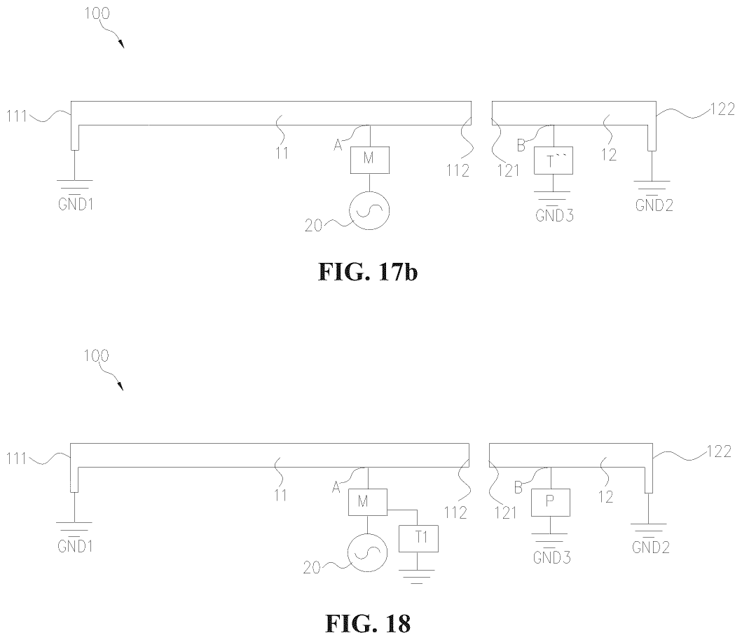

Referring to FIG. 17a, one end of the adjustable element Tis electrically connected to the tuning circuit P and the other end of the adjustable element T is electrically grounded, thus the second resonant mode b and the third resonant mode c can be tuned, thereby adjusting the resonant frequency of the second resonant mode b and the resonant frequency of the third resonant mode c.

In another implementation, referring to FIG. 17b, the adjustable element Tis integrated into the tuning circuit P to form a circuit T to tune the second resonant mode b and the third resonant mode c, thereby adjusting the resonant frequency of the second resonant mode b and the resonant frequency of the third resonant mode c. It can be understood that, integration of the adjustable element T into the tuning circuit P means that the adjustable element T may be part of the tuning circuit P. For example, the circuit T in FIG. 17b is a circuit formed by integrating the adjustable element Tinto the tuning circuit P.

Referring to FIG. 18, the at least one adjustable element T includes a first adjustable element T1 and a second adjustable element (not illustrated). One end of the first adjustable element T1 is electrically connected to the matching circuit M, and the other end of the first adjustable element T1 is grounded. The first adjustable element T1 is configured to tune the first resonant mode a and the fourth resonant mode d to tune the resonant frequency of the first resonant mode a and the resonant frequency of the fourth resonant mode d. The first adjustable element T1 may also be integrated into the matching circuit M. For details, reference may be made to the implementation in FIG. 16a, and details are not repeatedly described herein.

The second adjustable element can also be integrated into the tuning circuit P. T2 in FIG. 18 is a circuit formed by integrating the second adjustable element into the tuning circuit P. In other implementations, one end of the second adjustable element is electrically connected to the tuning circuit P, and the other end of the second adjustable element is electrically grounded. The second adjustable element T2 is configured to tune the second resonant mode b and the third resonant mode c to tune the resonant frequency of the second resonant mode b and the resonant frequency of the third resonant mode c. For details, reference may be made to the implementation in FIG. 17a, and details are not repeatedly described herein.

Optionally, the adjustable element T includes at least one of an antenna switch or a variable capacitor. Optionally, in a case where the adjustable element T includes the antenna switch, the adjustable element T further includes at least one of an inductor, a capacitor, or a resistor. At least one antenna switch, at least one inductor, at least one capacitor, and at least one resistor can be combined to form an adjusting-matching circuit with various impedances. The adjusting-matching circuit is electrically connected to the matching circuit M and/or the tuning circuit P. The adjusting-matching circuit can also be directly electrically connected to the first sub-radiator 11 or the second sub-radiator 12 to adjust a resonant frequency offset of the resonant mode. For example, in a case where the adjusting-matching circuit is capacitive, the adjusting-matching circuit allows a resonant frequency of a resonant mode to move towards a low frequency. In a case where the adjusting-matching circuit is inductive, the adjusting-matching circuit allows a resonant frequency of a resonant mode to move towards a high frequency. The tuning of the first to fourth resonant modes a-d can be achieved in the foregoing, so that the practical application bands can be better covered, and a bandwidth of the antenna assembly 100 is further widened.

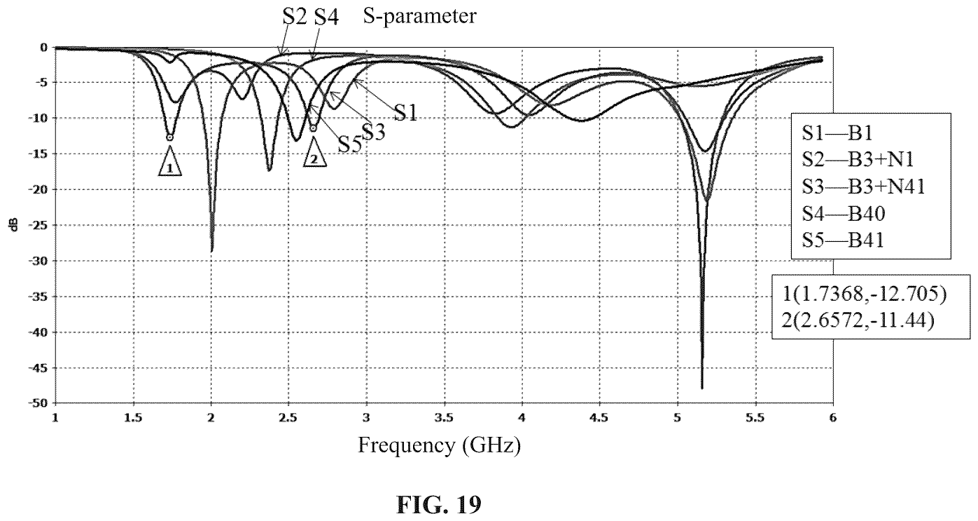

Referring to FIG. 19, with tuning of the adjustable element T, the resonant modes supported by the antenna assembly 100 are illustrated in the following curves. FIG. 19 illustrates curves S1 to S5 after the antenna switch or the variable capacitor of the adjustable element Tis adjusted, where each curve has high efficiency at a distinct band. For example, curve S1 can cover the B1 band and has high efficiency at the B1 band, the curve S2 can cover the B3+N1 bands and has a higher efficiency at the B3+N1 bands, the curve S3 can cover the B3+N41 bands and has a higher efficiency at the B3+N41 bands, the curve S4 can cover the B40 band and has a higher efficiency at the B40 band, and the curve S5 can cover the B41 band and has a higher efficiency at the B41 band. In this way, by arranging and adjusting the adjustable element T, the antenna assembly 100 can have a higher coverage efficiency at bands such as B1, B3+N1, B3+N41, B40, and B41. A band between the first point and the second point in FIG. 19 is 1736 MHz-2657 MHz, and it can be seen that there are six resonant modes between the first point and the second point (including the first point and the second point). In this way, full coverage of 1736 MHz-2657 MHz can be achieved by adjusting the adjustable element.

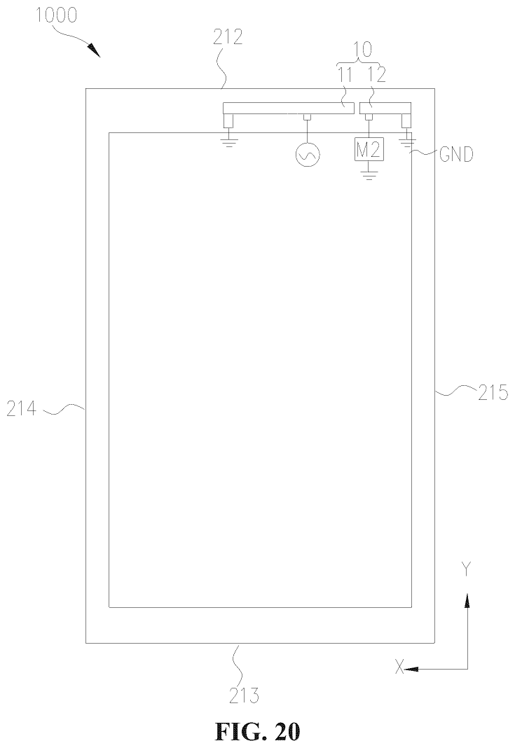

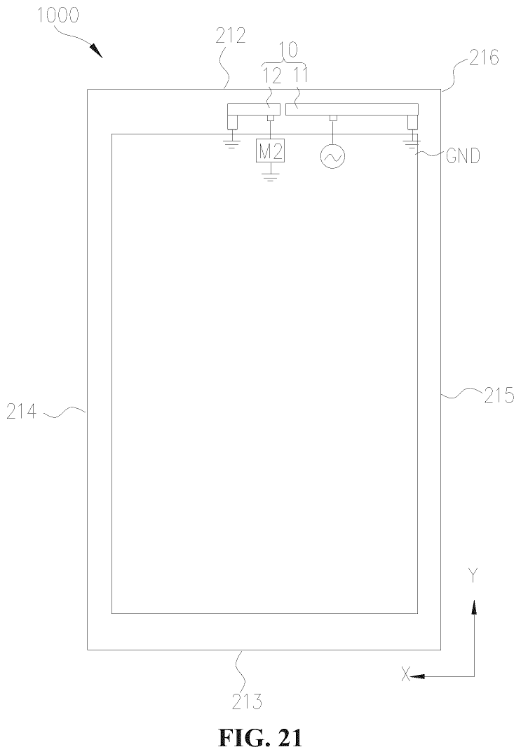

The disclosure does not specifically limit the specific position where the radiator 10 of the antenna assembly 100 is disposed at the electronic device 1000. For example, as illustrated in FIGS. 20 and 21, the entire radiator 10 of the antenna assembly 100 may be disposed at one side of the electronic device 1000. Alternatively, in other implementations, the radiator 10 of the antenna assembly 100 may be disposed at a corner of the electronic device 1000. Specifically, the following implementations are exemplified.

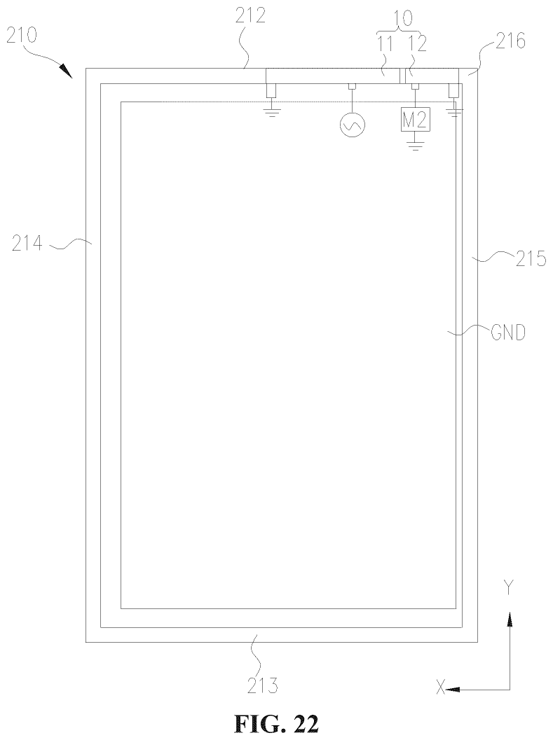

Referring to FIGS. 2 and 22, one side of the frame 210 is connected to a periphery of the rear cover 220, and the other side of the frame 210 is connected to a periphery of the display screen 300. The frame 210 includes multiple side frames connected end to end, and each two adjacent side frames of the multiple side frames of the frame 210 intersect with each other. For example, each two adjacent side frames are perpendicular to each other. The multiple side frames include a top frame 212 and a bottom frame 213 disposed opposite to each other, and a first side frame 214 and a second side frame 215 connected between the top frame 212 and the bottom frame 213. A connection between two adjacent side frames is a corner 216, where the top frame 212 is parallel to the bottom frame 213, and the top frame 212 is equal to the bottom frame 213 in length. The first side frame 214 is parallel to the second side frame 215, and the first side frame 214 is parallel to the second side frame 215 in length. The length of the first side frame 214 is greater than that of the top frame 212.

Referring to FIGS. 20 and 21, when an operator holds the electronic device 1000 to face a front face of the electronic device 1000, the top frame 212 is a side away from the ground, and the bottom frame 213 is a side facing the ground. Optionally, the entire radiator 10 is disposed at the top frame 212. In this way, during usage of the electronic device 1000 in a portrait orientation by a user, the radiator 10 faces an external space and is less sheltered, and efficiency of the antenna assembly 100 is higher. The antenna assembly 100 can be disposed at an upper right corner of the electronic device 1000. The antenna assembly 100 can be positioned at any position of the electronic device 1000.

The arrangement of the antenna assembly 100 is not specifically limited in the disclosure. Referring to FIG. 20, the radiator 10 is disposed at a position of the top frame 212 close to the second side frame 215, and the first sub-radiator 11 is disposed at a side of the second sub-radiator 12 away from the second side frame 215. Alternatively, referring to FIG. 21, the radiator 10 is disposed at a position of the top frame 212 close to the second side frame 215, and the second sub-radiator 12 is disposed at a side of the first sub-radiator 11 away from the second side frame 215.

Alternatively, the entire radiator 10 may be disposed at the second side frame 215. Thus, during usage of the electronic device 1000 in a landscape orientation by a user, the radiator 10 faces an external space and is less sheltered, and the efficiency of the antenna assembly 100 is higher. The entire radiator 10 may also be disposed at the first side frame 214.

Alternatively, the radiator 10 may be disposed at the corner 216 of the electronic device 1000. The antenna assembly 100 disposed at the corner 216 has a better efficiency, the environment of the antenna assembly 100 in the whole machine is also good, and the whole machine is easy to achieve stacking. Specifically, part of the radiator 10 is disposed at the at least one side frame, and another part of the radiator 10 is disposed at the corner 216. Specifically, the second sub-radiator 12 is disposed at the top frame 212, the coupling gap 13 is disposed at a side where the top frame 212 is located, and part of the first sub-radiator 11 is disposed corresponding to the top frame 212. Another part of the first sub-radiator 11 is disposed at the corner 216, and yet another part of the first sub-radiator 11 is disposed at a side where the second side frame 215 is located. In other words, the radiator 10 is disposed at the corner 216. In this way, when the handheld electronic device 1000 is being held, the radiator 10 is less sheltered, and the radiation efficiency of the radiator 10 is further improved.

Alternatively, referring to FIG. 22, at least part of the radiator 10 of the antenna assembly 100 is integrated with the frame 210. For example, the frame 210 is made of metal, and the first sub-radiator 11 and the second sub-radiator 12 are integrated with the frame 210. In other implementations, the radiator 10 may also be integrated with the rear cover 220, in other words, the first sub-radiator 11 and the second sub-radiator 12 are integrated as part of the housing 200. Specifically, the reference ground GND, the signal source 20, the matching circuit M, and the tuning circuit P of the antenna assembly 100 are all disposed at the circuit board.

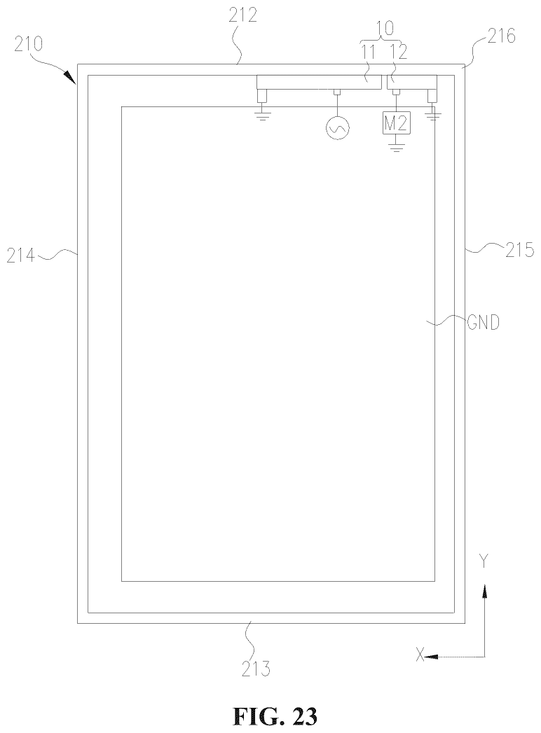

Alternatively, referring to FIG. 23, the first sub-radiator 11 and the second sub-radiator 12 may be formed on a surface of the frame 210. Specifically, the first sub-radiator 11 and the second sub-radiator 12 can be formed on an inner surface of the frame 210 through, but not limited to, processes such as patching, laser direct structuring (LDS), and print direct structuring (PDS). In the implementations, the frame 210 may be made of a non-conductive material, and the radiator 10 may also be disposed on the rear cover 220.

Alternatively, the first sub-radiator 11 and the second sub-radiator 12 are disposed at a flexible circuit board, and the flexible circuit board is attached to a surface of the frame 210. The first sub-radiator 11 and the second sub-radiator 12 may be integrated with the flexible circuit board, and the flexible circuit board is attached to the inner surface of the middle frame 420 by an adhesive or the like. In the implementations, the frame 210 may be made of a non-conductive material, and the radiator 10 may also be disposed on the inner surface of the rear cover 220.

The antenna assembly 100 provided in the disclosure is grounded by designing the structure of the radiator 10 and adding the tuning circuit P to the second sub-radiator 12, additional coexisting resonant modes are excited, and these resonant modes can realize ultra-wideband coverage, thus multi-band ENDC/CA performance can be achieved, a broadband antenna can be realized, MHB+UHB and MHB+MHB can be covered, thereby improving the throughput download speed, enhancing the user experience, lowing the costs, and satisfying the indexes of various operators.

The above are only some implementations of the disclosure. It is noted that, a person skilled in the art may make further improvements and modifications without departing from the principle of the disclosure, and these improvements and modifications shall also belong to the scope of protection of the disclosure.

What is claimed is:

1. An antenna assembly comprising:
a radiator comprising a first sub-radiator and a second sub-radiator, wherein the first sub-radiator and the second sub-radiator define a coupling gap therebetween, and the first sub-radiator is configured to be coupled to the second sub-radiator through the coupling gap; the first sub-radiator has a first grounding end, a first coupling end, and a feeding point disposed between the first grounding end and the first coupling end, wherein the first grounding end is grounded; the second sub-radiator has a second grounding end, a second coupling end, and a tuning point disposed between the second grounding end and the second coupling end, wherein the first coupling end is spaced apart from the second coupling end by the coupling gap, and the second grounding end is grounded;
a signal source electrically coupled to the feeding point; and
a tuning circuit, wherein one end of the tuning circuit is electrically connected to the tuning point, another end of the tuning circuit is grounded, and the tuning circuit is configured to tune the second sub-radiator to enable the second sub-radiator to be able to support at least two resonant modes.

2. The antenna assembly of claim 1, wherein the radiator is configured to support a first resonant mode, a second resonant mode, a third resonant mode, and a fourth resonant mode, wherein the first sub-radiator is configured to support two resonant modes among the first resonant mode, the second resonant mode, the third resonant mode, and the fourth resonant mode, and the second sub-radiator is configured to support the other two resonant modes among the first resonant mode, the second resonant mode, the third resonant mode, and the fourth resonant mode.

3. The antenna assembly of claim 2, wherein the first sub-radiator is configured to support the first resonant mode and the fourth resonant mode, the second sub-radiator is configured to support the second resonant mode and the third resonant mode, and a resonant frequency of the first resonant mode, a resonant frequency of the second resonant mode, a resonant frequency of the third resonant mode, and a resonant frequency of the fourth resonant mode increase in sequence.

4. The antenna assembly of claim 3, wherein each of the first resonant mode and the second resonant mode covers a middle-high band (MHB), and each of the third resonant mode and the fourth resonant mode covers an ultra-high band (UHB), wherein the MHB ranges from 1 GHz to 3 GHz, and the UHB is greater than or equal to 3 GHz.

5. The antenna assembly of claim 2, wherein each of the first resonant mode, the second resonant mode, the third resonant mode, and the fourth resonant mode covers at least one of 4^{th} generation (4G) long term evolution (LTE) band or 5^{th} generation (5G) New Radio (NR) band; when each of the first resonant mode, the second resonant mode, the third resonant mode, and the fourth resonant mode covers the 4G LTE band or the 5G NR band, a combination of a band covered by the first resonant mode, a band covered by the second resonant mode, a band covered by the third resonant mode, and a band covered by the fourth resonant mode forms a target application band, wherein the target application band covers 1.45 GHz-6 GHz.

6. The antenna assembly of claim 2, wherein a first resonant current corresponding to the first resonant mode is distributed between the first grounding end and the second grounding end, and part of the first sub-radiator between the first grounding end and the first coupling end is configured to support the first resonant mode under excitation of the first resonant current.

7. The antenna assembly of claim 2, wherein a second resonant current corresponding to the second resonant mode is distributed between the feeding point and the second grounding end, and part of the second sub-radiator between the second grounding end and the second coupling end is configured to support the second resonant mode under excitation of the second resonant current.

8. The antenna assembly of claim 2, wherein a third resonant current corresponding to the third resonant mode is distributed between the feeding point and the tuning point, and part of the second sub-radiator between the tuning point and the second coupling end is configured to support the third resonant mode under excitation of the third resonant current.

9. The antenna assembly of claim 2, wherein a fourth resonant current corresponding to the fourth resonant mode is distributed between the first grounding end and the tuning point, wherein a part of the fourth resonant current flows from the first grounding end to a current reverse point, and another part of the fourth resonant current flows from the tuning point to the current reverse point through the coupling gap, the current reverse point is located between the feeding point and the first grounding end, and part of the first sub-radiator between the first grounding end and the first coupling end is configured to support the fourth resonant mode under excitation of the fourth resonant current.

10. The antenna assembly of claim 2, wherein the tuning circuit is inductive at both a resonant point of the first resonant mode and a resonant point of the second resonant mode, and the tuning circuit is capacitive at a resonant point of the third resonant mode and is inductive at a resonant point of the fourth resonant mode.

11. The antenna assembly of claim 10, wherein the tuning circuit comprises a first capacitor unit and a first inductor unit, wherein one end of the first capacitor unit and one end of the first inductor unit are both electrically connected to the tuning point, and another end of the first capacitor unit and another end of the first inductor unit are both grounded.

12. The antenna assembly of claim 11, wherein the tuning circuit further comprises a second inductor unit, one end of the second inductor unit is electrically connected to a node where the other end of the first capacitor unit is connected to another end of the first inductor unit, and another end of the second inductor unit is grounded.

13. The antenna assembly of claim 10, wherein the tuning circuit comprises a first capacitor unit, a second inductor unit, and a first inductor unit connected in series to the first capacitor unit, wherein both one end of the first inductor and one end of the second inductor unit are electrically connected to the tuning point, and another end of the second inductor unit and one end of the first capacitor unit are electrically connected to each other and grounded.

14. The antenna assembly of claim 12, wherein the tuning circuit further comprises a second capacitor unit, one end of the second capacitor unit is electrically connected to the one end of the second inductor unit, and another end of the second capacitor unit and the other end of the second inductor unit are electrically connected to each other and grounded.

15. The antenna assembly of claim 2, wherein the tuning circuit comprises a tuning capacitor, one end of the tuning capacitor is electrically connected to the tuning point, and another end of the tuning capacitor is grounded.

16. The antenna assembly of claim 2, further comprising a matching circuit, wherein one end of the matching circuit is electrically connected to the feeding point, and another end of the matching circuit is electrically connected to the signal source.

17. The antenna assembly of claim 16, wherein the matching circuit comprises a first matching unit and a second matching unit, wherein:
each of the first matching unit and the second matching unit comprises a capacitor and an inductor, one end of the first matching unit is electrically connected to the feeding point, another end of the first matching unit is electrically connected to one end of the second matching unit, and yet another end of the first matching unit is electrically grounded;
another end of the second matching unit is electrically connected to the signal source, and still another end of the second matching unit is electrically grounded;
the first matching unit is configured to tune one of the first resonant mode and the third resonant mode, and the second matching unit is configured to tune another one of the first resonant mode and the third resonant mode; and
the first matching unit and the second matching unit are configured to cooperatively tune the second resonant mode and the fourth resonant mode.

18. The antenna assembly of claim 17, wherein at least one of the following:
the first matching unit comprises a first capacitor and a first inductor, one end of the first capacitor is electrically connected to the feeding point, another end of the first capacitor is electrically connected to the one end of the second matching unit, one end of the first inductor is electrically connected to the feeding point, and another end of the first inductor is electrically grounded; or
the second matching unit comprises a second capacitor and a second inductor, one end of the second capacitor is electrically connected to the another end of the first matching unit, another end of the second capacitor is electrically grounded, one end of the second inductor is electrically connected to the another end of the first matching unit, and another end of the second inductor is electrically connected to the signal source.

19. The antenna assembly of claim 16, comprising at least one adjustable element, the at least one adjustable element comprising at least one of an antenna switch or a variable capacitor, wherein one of the following:
one end of the at least one adjustable element is electrically connected to the matching circuit, and another end of the at least one adjustable element is grounded;
the at least one adjustable element is integrated into the matching circuit to tune the first resonant mode and the fourth resonant mode;
one end of the at least one adjustable element is electrically connected to the tuning circuit, and another end of the at least one adjustable element is electrically grounded; and
the at least one adjustable element is integrated into the tuning circuit to tune the second resonant mode and the third resonant mode.

20. An electronic device, comprising:
a housing and an antenna assembly;
wherein the antenna assembly comprises:
a radiator comprising a first sub-radiator and a second sub-radiator, wherein the first sub-radiator and the second sub-radiator define a coupling gap therebetween, and the first sub-radiator is configured to be coupled to the second sub-radiator through the coupling gap; the first sub-radiator has a first grounding end, a first coupling end, and a feeding point disposed between the first grounding end and the first coupling end, wherein the first grounding end is grounded; the second sub-radiator has a second grounding end, a second coupling end, and a tuning point disposed between the second grounding end and the second coupling end, wherein the first coupling end is spaced apart from the second coupling end by the coupling gap, and the second grounding end is grounded;
a signal source electrically coupled to the feeding point; and
a tuning circuit, wherein one end of the tuning circuit is electrically connected to the tuning point, another end of the tuning circuit is grounded, and the tuning circuit is configured to tune the second sub-radiator to enable the second sub-radiator to be able to support at least two resonant modes; and
wherein the radiator is attached to the housing, and the tuning circuit and the signal source are disposed in the housing.
